(19) United States
(12) Patent Application Publication
(10) Pub. No.: US 2016/0365743 A1
(43) Pub. Date: Dec. 15, 2016

(54) NEAR FIELD COMMUNICATION WIRELSS CHARGING APPARATUS

(71) Applicant: Jogtek Corp., Taipei City (TW)

(72) Inventors: Wei-Chun HUANG, Taipei City (TW); Tsung-Hsing HSIEH, Taipei City (TW)

(21) Appl. No.: 14/957,833

(22) Filed: Dec. 3, 2015

(30) Foreign Application Priority Data
Jun. 10, 2015 (TW) 104209257

(51) Int. Cl. H02J 7/02; H04W 4/00; H02J 7/04; H04B 5/00

(52) U.S. Cl. CPC H02J 7/025; H04B 5/0037; H04W 4/008; H02J 7/047; H02J 7/045

(57) ABSTRACT

A near field communication wireless charging apparatus includes an antenna, an antenna switching unit, a control unit, a near field communication unit and a charging unit. The antenna comprises a first contact, a second contact and a third contact. When the near field communication wireless charging apparatus works in a wireless communication mode, the control unit controls the antenna switching unit, so that the near field communication unit is connected to the first contact and the second contact through the antenna switching unit, and the charging unit is not connected to the antenna. When the near field communication wireless charging apparatus works in a wireless charging mode, the control unit controls the antenna switching unit, so that the charging unit is connected to the first contact and the third contact through the antenna switching unit, and the near field communication unit is not connected to the antenna.

### BACKGROUND OF THE INVENTION

1. Field of the Invention

The present invention relates to a wireless charging apparatus, and especially relates to a near field communication wireless charging apparatus.

2. Description of the Related Art

Near field communication (NFC) is a very common wireless communication protocol technology. A lot of smart phones have near field communication functions. Wireless charging is a new charging method and charges wirelessly without lines. It is very convenient. Some related art combine near field communication and wireless charging. However, in order to transmit data and wirelessly charge, the circuits of the related art are usually very complicated. It is a pity.

### SUMMARY OF THE INVENTION

In order to solve the above-mentioned problems, an object of the present invention is to provide a near field communication wireless charging apparatus.

In order to achieve the object of the present invention mentioned above, the near field communication wireless charging apparatus comprises an antenna, an antenna switching unit, a control unit, a near field communication unit and a charging unit. The antenna has an antenna first contact, an antenna second contact and an antenna third contact. The antenna switching unit is electrically connected to the antenna. The control unit is electrically connected to the antenna switching unit. The near field communication unit is electrically connected to the antenna switching unit and the control unit. The charging unit is electrically connected to the antenna switching unit and the control unit. The antenna first contact and the antenna third contact are arranged at two sides of the antenna respectively. The antenna second contact is arranged between the antenna first contact and the antenna third contact. When the near field communication wireless charging apparatus works in a wireless communication mode, the control unit controls the antenna switching unit, so that the near field communication unit is connected to the antenna first contact and the antenna second contact through the antenna switching unit, and the charging unit is not connected to the antenna. When the near field communication wireless charging apparatus works in a wireless charging mode, the control unit controls the antenna switching unit, so that the charging unit is connected to the antenna first contact and the antenna third contact through the antenna switching unit, and the near field communication unit is not connected to the antenna.

Moreover, the near field communication unit comprises a near field communication first contact and a near field communication second contact. When the near field communication wireless charging apparatus works in the wireless communication mode, the control unit controls the antenna switching unit, so that the near field communication first contact is connected to the antenna first contact through the antenna switching unit, and the near field communication second contact is connected to the antenna second contact through the antenna switching unit. Moreover, the charging unit comprises a charging first contact and a charging second contact.

When the near field communication wireless charging apparatus works in the wireless charging mode, the control unit controls the antenna switching unit, so that the charging first contact is connected to the antenna first contact through the antenna switching unit, and the charging second contact is connected to the antenna third contact through the antenna switching unit. Moreover, the near field communication wireless charging apparatus further comprises a near field communication side matching unit electrically connected to the antenna switching unit and the near field communication unit.

Moreover, the near field communication wireless charging apparatus further comprises a charging side matching unit electrically connected to the antenna switching unit and the charging unit.

Moreover, the near field communication wireless charging apparatus further comprises an analog-to-digital converting unit electrically connected to the control unit.

Moreover, the near field communication wireless charging apparatus further comprises a temperature sensing unit electrically connected to the analog-to-digital converting unit. The temperature sensing unit senses a temperature of the near field communication wireless charging apparatus and informs the control unit of the temperature of the near field communication wireless charging apparatus through the analog-to-digital converting unit. When the temperature of the near field communication wireless charging apparatus is higher than a predetermined temperature, the control unit controls the antenna switching unit, so that both of the near field communication unit and the charging unit are not connected to the antenna.

Moreover, the near field communication wireless charging apparatus further comprises a voltage detecting unit electrically connected to the analog-to-digital converting unit, the antenna switching unit, the antenna first contact and the antenna third contact. The voltage detecting unit detects a voltage between the antenna first contact and the antenna third contact, and informs the control unit of the voltage between the antenna first contact and the antenna third contact through the analog-to-digital converting unit. When the voltage between the antenna first contact and the antenna third contact is not in a predetermined voltage range, the control unit controls the antenna switching unit, so that both of the near field communication unit and the charging unit are not connected to the antenna. Moreover, the antenna switching unit is, for example but not limited to, a high frequency antenna switcher. The control unit is, for example but not limited to, a microcontroller or a microprocessor. The near field communication unit is, for example but not limited to, a near field communication circuit. The charging unit is, for example but not limited to, a charging circuit.

Moreover, the near field communication side matching unit is, for example but not limited to, a matching circuit. The charging side matching unit is, for example but not limited to, a matching circuit. The analog-to-digital converting unit is, for example but not limited to, an analog-to-digital converting circuit. The temperature sensing unit is, for example but not limited to, a temperature sensor. The voltage detecting unit is, for example but not limited to, a voltage detecting circuit.

The advantage of the present invention is to provide a communication apparatus which has simple circuits to wirelessly communicate and wirelessly charge.

### BRIEF DESCRIPTION OF DRAWING

FIG. 1 shows a block diagram of the first embodiment of the near field communication wireless charging apparatus of the present invention.

FIG. 2 shows a block diagram of the second embodiment of the near field communication wireless charging apparatus of the present invention.

### DETAILED DESCRIPTION OF THE INVENTION

Please refer to following detailed description and figures for the technical content of the present invention. The following detailed description and figures are referred for the present invention, but the present invention is not limited to it.

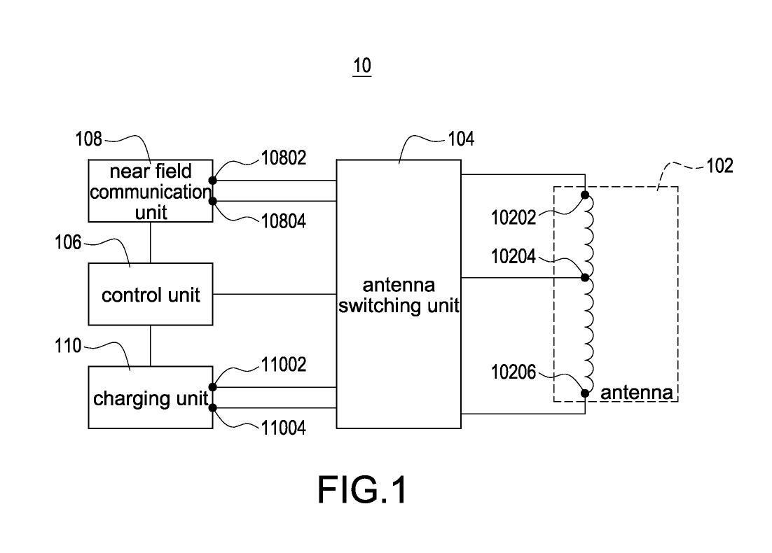

FIG. 1 shows a block diagram of the first embodiment of the near field communication wireless charging apparatus of the present invention. A near field communication wireless charging apparatus 10 comprises an antenna 102, an antenna switching unit 104, a control unit 106, a near field communication unit 108 and a charging unit 110. The antenna 102 comprises an antenna first contact 10202, an antenna second contact 10204 and an antenna third contact 10206. The near field communication unit 108 comprises a near field communication first contact 10802 and a near field communication second contact 10804. The charging unit 110 comprises a charging first contact 11002 and a charging second contact 11004. The antenna first contact 10202 and the antenna third contact 10206 are arranged at two sides of the antenna 102 respectively. The antenna second contact 10204 is arranged between the antenna first contact 10202 and the antenna third contact 10206. Therefore, an antenna inductance value between the antenna first contact 10202 and the antenna third contact 10206 is greater than an antenna inductance value between the antenna first contact 10202 and the antenna second contact 10204.

The antenna switching unit 104 is electrically connected to the antenna 102. The control unit 106 is electrically connected to the antenna switching unit 104. The near field communication unit 108 is electrically connected to the antenna switching unit 104 and the control unit 106. The charging unit 110 is electrically connected to the antenna switching unit 104 and the control unit 106.

When the near field communication wireless charging apparatus 10 works in a wireless communication mode (namely, communicating data with other wireless communication apparatuses through near field communication technology), the control unit 106 controls the antenna switching unit 104, so that the near field communication unit 108 is connected to the antenna first contact 10202 and the antenna second contact 10204 through the antenna switching unit 104, and the charging unit 110 is not connected to the antenna 102. In another word, when the near field communication wireless charging apparatus 10 works in the wireless communication mode, the control unit 106 controls the antenna switching unit 104, so that the near field communication first contact 10802 is connected to the antenna first contact 10202 through the antenna switching unit 104, and the near field communication second contact 10804 is connected to the antenna second contact 10204 through the antenna switching unit 104.

When the near field communication wireless charging apparatus 10 works in a wireless charging mode (namely, wirelessly charging to other wireless apparatuses, or being wirelessly charged by other wireless apparatuses), the control unit 106 controls the antenna switching unit 104, so that the charging unit 110 is connected to the antenna first contact 10202 and the antenna third contact 10206 through the antenna switching unit 104, and the near field communication unit 108 is not connected to the antenna 102. In another word, when the near field communication wireless charging apparatus 10 works in the wireless charging mode, the control unit 106 controls the antenna switching unit 104, so that the charging first contact 11002 is connected to the antenna first contact 10202 through the antenna switching unit 104, and the charging second contact 11004 is connected to the antenna third contact 10206 through the antenna switching unit 104.

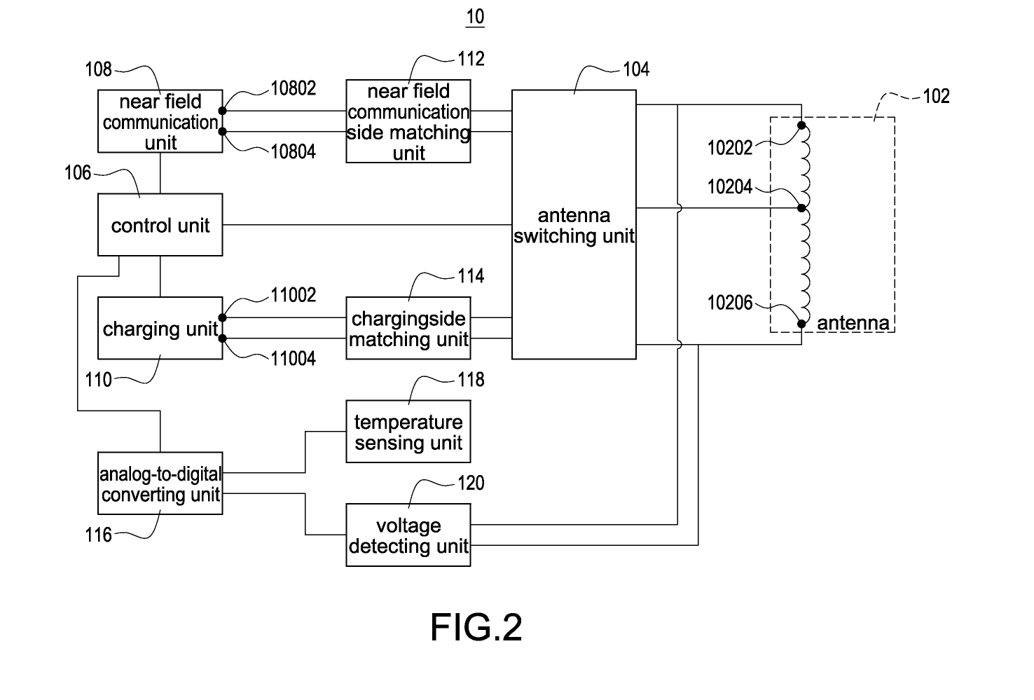

FIG. 2 shows a block diagram of the second embodiment of the near field communication wireless charging apparatus of the present invention. The description for the elements shown in FIG. 2, which are similar to those shown in FIG. 1, is not repeated here for brevity. Moreover, the near field communication wireless charging apparatus 10 further comprises a near field communication side matching unit 112, a charging side matching unit 114, an analog-to-digital converting unit 116, a temperature sensing unit 118 and a voltage detecting unit 120.

The near field communication side matching unit 112 is electrically connected to the antenna switching unit 104 and the near field communication unit 108. The charging side matching unit 114 is electrically connected to the antenna switching unit 104 and the charging unit 110. The analog-to-digital converting unit 116 is electrically connected to the control unit 106. The temperature sensing unit 118 is electrically connected to the analog-to-digital converting unit 116. The voltage detecting unit 120 is electrically connected to the analog-to-digital converting unit 116, the antenna switching unit 104, the antenna first contact 10202 and the antenna third contact 10206.

The temperature sensing unit 118 senses a temperature of the near field communication wireless charging apparatus 10 and informs the control unit 106 of the temperature of the near field communication wireless charging apparatus 10 through the analog-to-digital converting unit 116. When the temperature of the near field communication wireless charging apparatus 10 is higher than a predetermined temperature (namely, overheating due to incorrectly wirelessly charging), the control unit 106 controls the antenna switching unit 104, so that both of the near field communication unit 108 and the charging unit 110 are not connected to the antenna 102. Therefore, the near field communication wireless charging apparatus 10 is protected from overheating in the wireless charging mode, and this mechanism can also avoid other dangerous events happening.

The voltage detecting unit 120 detects a voltage between the antenna first contact 10202 and the antenna third contact 10206, and informs the control unit 106 of the voltage between the antenna first contact 10202 and the antenna third contact 10206 through the analog-to-digital converting unit 116. When the voltage between the antenna first contact 10202 and the antenna third contact 10206 is not in a predetermined voltage range (namely, incorrect voltages being generated due to incorrectly wirelessly charging), the control unit 106 controls the antenna switching unit 104, so that both of the near field communication unit 108 and the charging unit 110 are not connected to the antenna 102. Therefore, the near field communication wireless charging apparatus 10 is protected in the wireless charging mode, and this mechanism can also avoid other dangerous events happening.

Especially, a metal (for example, a copper coin) existing between the wireless charging apparatus and the wireless being-charged apparatus is very dangerous. The metal will be heated up very quickly. The temperature sensing unit 118 and the voltage detecting unit 120 of the present invention are the mechanisms to avoid such problems happening (namely, foreign matters existing). For example, if the metal exists between the wireless charging apparatus and the wireless being-charged apparatus, the temperature of the near field communication wireless charging apparatus 10 will be overheating, or the voltage between the antenna first contact 10202 and the antenna third contact 10206 will be abnormal. At this time, the temperature sensing unit 118 or the voltage detecting unit 120 can sense or detect the problems to stop working (namely, stop both charging and communicating data) to protect the near field communication wireless charging apparatus 10, or to avoid heating the metal.

The near field communication wireless charging apparatus 10 is, for example but not limited to, a smart phone with near field communication charging function, or a wireless charging apparatus with near field communication charging function. The antenna switching unit 104 is, for example but not limited to, a high frequency antenna switcher. The control unit 106 is, for example but not limited to, a microcontroller or a microprocessor. The near field communication unit 108 is, for example but not limited to, a near field communication circuit. The charging unit 110 is, for example but not limited to, a charging circuit. The near field communication side matching unit 112 is, for example but not limited to, a matching circuit.

The charging side matching unit 114 is, for example but not limited to, a matching circuit. The analog-to-digital converting unit 116 is, for example but not limited to, an analog-to-digital converting circuit. The temperature sensing unit 118 is, for example but not limited to, a temperature sensor. The voltage detecting unit 120 is, for example but not limited to, a voltage detecting circuit.

The advantage of the present invention is to provide a communication apparatus which has simple circuits to wirelessly communicate and wirelessly charge.

Although the present invention has been described with reference to the preferred embodiment thereof, it will be understood that the invention is not limited to the details thereof Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A near field communication wireless charging apparatus comprising:
an antenna having an antenna first contact, an antenna second contact and an antenna third contact, the antenna first contact and the antenna third contact arranged at two sides of the antenna respectively, the antenna second contact arranged between the antenna first contact and the antenna third contact;
an antenna switching unit electrically connected to the antenna;
a control unit electrically connected to the antenna switching unit;
a near field communication unit electrically connected to the antenna switching unit and the control unit; and
a charging unit electrically connected to the antenna switching unit and the control unit,
wherein when the near field communication wireless charging apparatus works in a wireless communication mode, the control unit controls the antenna switching unit, so that the near field communication unit is connected to the antenna first contact and the antenna second contact through the antenna switching unit, and the charging unit is not connected to the antenna; when the near field communication wireless charging apparatus works in a wireless charging mode, the control unit controls the antenna switching unit, so that the charging unit is connected to the antenna first contact and the antenna third contact through the antenna switching unit, and the near field communication unit is not connected to the antenna.

2. The near field communication wireless charging apparatus in claim 1, wherein the near field communication unit comprises a near field communication first contact and a near field communication second contact; when the near field communication wireless charging apparatus works in the wireless communication mode, the control unit controls the antenna switching unit, so that the near field communication first contact is connected to the antenna first contact through the antenna switching unit, and the near field communication second contact is connected to the antenna second contact through the antenna switching unit.

3. The near field communication wireless charging apparatus in claim 2, wherein the charging unit comprises a charging first contact and a charging second contact; when the near field communication wireless charging apparatus works in the wireless charging mode, the control unit controls the antenna switching unit, so that the charging first contact is connected to the antenna first contact through the antenna switching unit, and the charging second contact is connected to the antenna third contact through the antenna switching unit.

4. The near field communication wireless charging apparatus in claim 3, further comprising:
a near field communication side matching unit electrically connected to the antenna switching unit and the near field communication unit.

5. The near field communication wireless charging apparatus in claim 4, further comprising:
a charging side matching unit electrically connected to the antenna switching unit and the charging unit.

6. The near field communication wireless charging apparatus in claim 5, further comprising:
an analog-to-digital converting unit electrically connected to the control unit.

7. The near field communication wireless charging apparatus in claim 6, further comprising:
a temperature sensing unit electrically connected to the analog-to-digital converting unit.

8. The near field communication wireless charging apparatus in claim 7, further comprising:
a voltage detecting unit electrically connected to the analog-to-digital converting unit, the antenna switching unit, the antenna first contact and the antenna third contact.

9. The near field communication wireless charging apparatus in claim 8, wherein the antenna switching unit is a high frequency antenna switcher; the control unit is a microcontroller or a microprocessor; the near field communication unit is a near field communication circuit; the charging unit is a charging circuit.

10. The near field communication wireless charging apparatus in claim 9, wherein the near field communication side matching unit is a matching circuit; the charging side matching unit is a matching circuit; the analog-to-digital converting unit is an analog-to-digital converting circuit; the temperature sensing unit is a temperature sensor; the voltage detecting unit is a voltage detecting circuit.
